(19) United States
(12) Patent Application Publication
(10) Pub. No.: US 2024/0319635 A1
(43) Pub. Date: Sep. 26, 2024

(54) ROTATING-BODY COOLING STRUCTURE, FIXING DEVICE, MEDIUM ADJUSTMENT DEVICE, AND IMAGE FORMING APPARATUS

(71) Applicant: FUJIFILM Business Innovation Corp., Tokyo (JP)

(72) Inventors: Koji YOSHITSUGU, Kanagawa (JP); Yuka NOMURA, Kanagawa (JP); Yasuhisa GONDA, Kanagawa (JP)

(73) Assignee: FUJIFILM Business Innovation Corp., Tokyo (JP)

(21) Appl. No.: 18/355,851

(22) Filed: Jul. 20, 2023

(30) Foreign Application Priority Data
Mar. 23, 2023 (JP) 2023-046362

(51) Int. Cl. G03G 15/20; F28D 21/00

(52) U.S. Cl. CPC G03G 15/2017; F28D 21/00; F28D 2021/0029

(57) ABSTRACT

A rotating-body cooling structure includes: a rotating body that increases in temperature as a result of receiving heat from an outside; and a heat dissipator that is in contact with an outer peripheral surface of the rotating body with a sliding member interposed therebetween.

### CROSS-REFERENCE TO RELATED APPLICATIONS

This application is based on and claims priority under 35 USC 119 from Japanese Patent Application No. 2023-046362 filed Mar. 23, 2023.

### BACKGROUND

### (i) Technical Field

The present disclosure relates to rotating-body cooling structures, fixing devices, medium adjustment devices, and image forming apparatuses.

### (ii) Related Art

For example, Japanese Unexamined Patent Application Publication No. 2008-152045 (claim 1, FIGS. 2 to 5) describes a known technology in the related art for cooling a rotating body that increases in temperature as a result of receiving heat from the outside.

Japanese Unexamined Patent Application Publication No. 2008-152045 (claim 1, FIGS. 2 to 5) describes, for example, a fixing device that includes a pressing-member cooling mechanism. The pressing-member cooling mechanism cools a pressing member constituted of a pressing roller that forms a pressing region together with a fixing roller constituted of a fixing module to be heated.

In Japanese Unexamined Patent Application Publication No. 2008-152045 (claim 1, FIGS. 2 to 5), the pressing-member cooling mechanism includes a heat-absorbing member that faces the pressing member and that absorbs heat of the pressing member, a conduction belt member that is revolvable around the heat-absorbing member and that conducts the heat of the pressing member to the heat-absorbing member, and a heat-absorbing-member cooling unit that cools the heat-absorbing member.

### SUMMARY

Aspects of non-limiting embodiments of the present disclosure relate to suppressing noise while efficiently cooling a rotating body in a cooling structure for cooling the rotating body that increases in temperature as a result of receiving heat from the outside, as compared with a case where a heat dissipator that is in contact with the outer peripheral surface of the rotating body with a sliding member interposed therebetween is not used.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a rotating-body cooling structure comprising: a rotating body that increases in temperature as a result of receiving heat from an outside; and a heat dissipator that is in contact with an outer peripheral surface of the rotating body with a sliding member interposed therebetween.

### BRIEF DESCRIPTION OF THE DRAWINGS

Exemplary embodiments of the present disclosure will be described in detail based on the following figures, wherein:

FIG. 1 schematically illustrates an image forming apparatus according to a first exemplary embodiment;

FIG. 2 schematically illustrates a part (i.e., a fixing device equipped with a rotating-body cooling structure) of the image forming apparatus in FIG. 1;

FIG. 3A is a schematic cross-sectional view illustrating a part (excluding an air blower) of the rotating-body cooling structure according to the first exemplary embodiment, and FIG. 3B is a schematic cross-sectional view of the part of the cooling structure in FIG. 3A, taken along line IIIB-IIIB;

FIG. 4A is a schematic perspective view of a heat dissipator in the cooling structure in FIGS. 3A and 3B, and FIG. 4B is a schematic bottom view of the heat dissipator in FIG. 4A, when viewed from below;

FIG. 5A is a schematic enlarged partial view of the fixing device and the cooling structure in FIG. 2, and FIG. 5B is a schematic plan view of a part of the cooling structure in FIG. 5A, as viewed from above;

FIG. 6 schematically illustrates an operating state of the cooling structure in the fixing device in FIG. 2;

FIG. 7 schematically illustrates a fixing device equipped with a rotating-body cooling structure according to a second exemplary embodiment;

FIG. 8 schematically illustrates an operating state of the cooling structure in the fixing device in FIG. 7;

FIG. 9 schematically illustrates an uncurling device equipped with rotating-body cooling structures according to a third exemplary embodiment;

FIG. 10 schematically illustrates a medium cooling device equipped with a rotating-body cooling structure according to a fourth exemplary embodiment; and

FIG. 11 schematically illustrates a modification of a part (air blower) of the rotating-body cooling structure in FIG. 2.

### DETAILED DESCRIPTION

Exemplary embodiments of the present disclosure will be described below.

### First Exemplary Embodiment

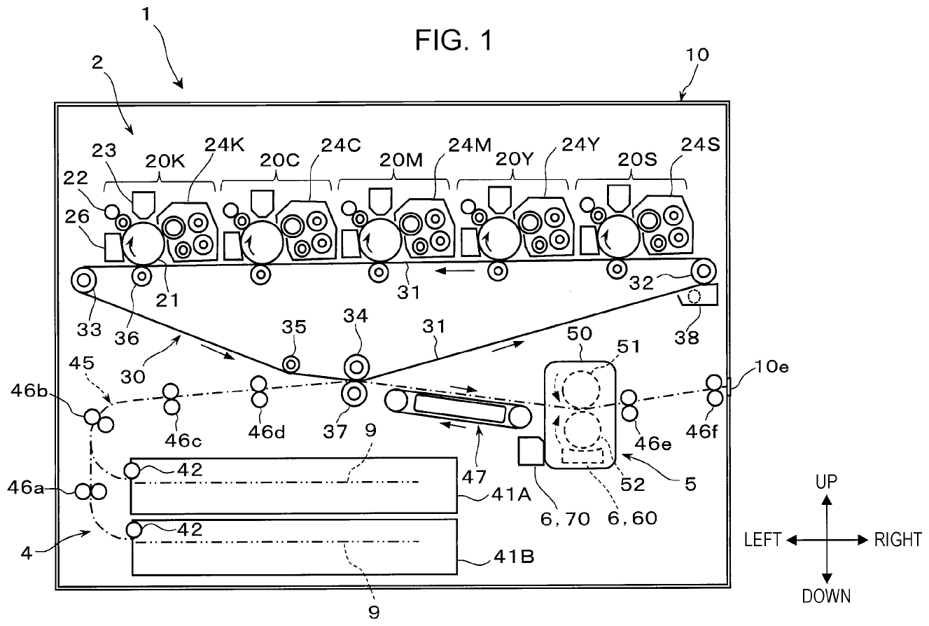

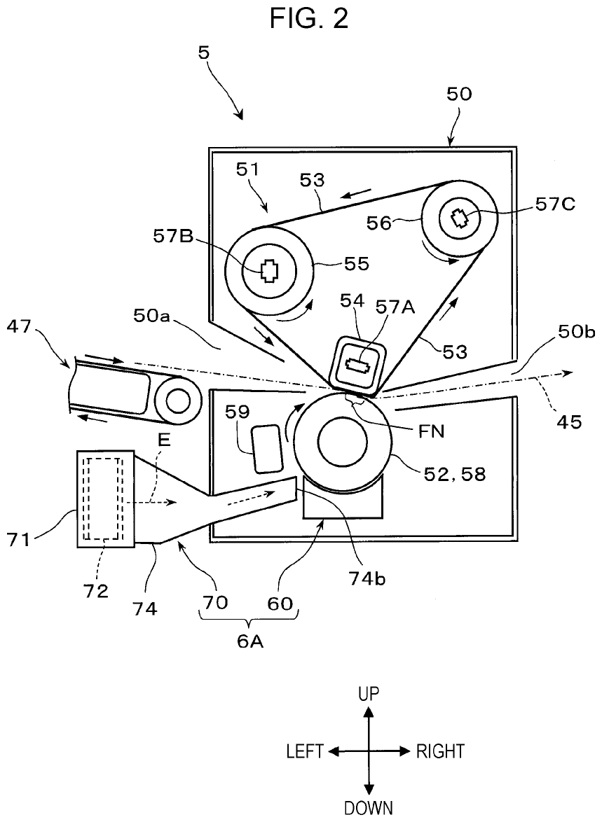

FIG. 1 schematically illustrates an image forming apparatus according to a first exemplary embodiment of the present disclosure. FIG. 2 schematically illustrates a fixing device equipped with a rotating-body cooling structure in the image forming apparatus in FIG. 1.

In this description and the drawings, substantially identical components will be given the same reference signs, and redundant descriptions of such identical components will be omitted in this description.

### 1.1. Configuration of Image Forming Apparatus

As shown in FIG. 1, an image forming apparatus 1 forms an image onto recording paper 9 as an example of a recording medium. For example, the image forming apparatus 1 is connectable to an external apparatus, such as an information terminal, and is capable of forming an image corresponding to image information input therefrom.

As shown in FIG. 1, the image forming apparatus 1 includes an image forming section 2, a medium feeding device 4, a fixing device 5, and a controller (not shown) that are provided within an internal space of a housing 10.

The housing 10 is a box-shaped structure formed into a predetermined external shape by using a structural component, such as a frame, and cover components, such as a panel and an openable-closable door. In FIG. 1, a single-dot chain line denotes a transport path 45 along which the recording paper 9 is transported within the housing 10.

The image forming section 2 is where unfixed images are formed and are transferred onto the recording paper 9. The image forming section 2 includes image forming units 20 that form unfixed images and an intermediate transfer unit 30 that relays and transfers the unfixed images formed at the image forming units 20 onto the recording paper 9.

The image forming units 20 are a group of units configured to form toner images formed of toners serving as developers based on the image information.

The image forming units 20 according to the first exemplary embodiment include image forming units 20Y, 20M, 20C, 20K, and 20S (sometimes abbreviated as 20 (Y, M. C. K. S) hereinafter) that independently and dedicatedly form toner images of, for example, yellow (Y), magenta (M), cyan (C), black (K), and special (S) colors. The special color (S) is, for example, a white color or a transparent color.

The image forming units 20Y, 20M, 20C, 20K, and 20S have substantially similar configurations except for the fact that the colors of developers (i.e., toners in this example) respectively used in developing devices 24 and abbreviated as Y, M. C. K, and S are different from one another.

Specifically, the image forming units 20 (Y, M, C. K. S) each have a photoconductor drum 21 as an example of a latent-image bearing member on which a latent image is formed and retained. In each of the image forming units 20 (Y, M. C. K. S), the photoconductor drum 21 is surrounded by devices, such as a charging device 22, an exposure device 23, a developing device 24 (Y, M, C. K. S), a first-transfer device 36, and a drum cleaning device 26.

When the image forming apparatus 1 is viewed from the front surface, the image forming units 20 (Y, M. C. K. S) are arranged in series at a predetermined pitch in the left-right direction within the internal space of the housing 10. The front surface is treated as the surface at the front side of the image forming apparatus 1.

In FIG. 1, the photoconductor drum 21, the charging device 22, the exposure device 23, the developing device 24K, the first-transfer device 36, and the drum cleaning device 26 in the image forming unit 20K are given their respective reference signs. In FIG. 1, for the remaining image forming units 20 (Y, M. C. S), only the developing devices 24 (Y, M. C. S) are given their respective reference signs, whereas other reference signs are omitted.

The photoconductor drum 21 is a drum-shaped photoconductor that extends in the front-rear direction and that rotates in a direction indicated by an arrow around a rotation axis (not shown).

The charging device 22 electrostatically charges the outer peripheral surface serving as an image forming surface of the photoconductor drum 21 to a predetermined surface potential. The charging device 22 includes a charging member, such as a charging roller, which is in contact with an image forming region on the outer peripheral surface of the photoconductor drum 21 and which is supplied with a charging current.

The exposure device 23 exposes the electrostatically-charged outer peripheral surface of the photoconductor drum 21 to light based on the image information so as to form an electrostatic latent image thereon.

The developing device 24 turns the electrostatic latent image formed on the outer peripheral surface of the photoconductor drum 21 into a toner image as an example of an unfixed image by developing the electrostatic latent image using a developer of the corresponding predetermined color (i.e., any one of the Y, M. C. K, and S colors).

The first-transfer device 36 transfers the toner image formed on the outer peripheral surface of the photoconductor drum 21 in each image forming unit 20 (Y, M, C, K, S) onto an intermediate transfer belt 31 of the intermediate transfer unit 30. The first-transfer device 36 includes a transfer member, such as a transfer roller, which is in contact with the outer peripheral surface of the photoconductor drum 21 and which is supplied with a first-transfer current. If the intermediate transfer unit 30 is employed, the first-transfer device 36 is treated as one component included in the intermediate transfer unit 30.

The drum cleaning device 26 cleans the outer peripheral surface of the photoconductor drum 21 by removing waste, such as unwanted toner and paper particles, from the outer peripheral surface of the photoconductor drum 21.

The intermediate transfer unit 30 is a group of devices that temporarily retain the toner images formed at the image forming units 20 (Y, M. C. K. S) on an intermediate transfer body and that subsequently transfer the toner images onto the recording paper 9.

The intermediate transfer unit 30 includes, for example, the intermediate transfer belt 31 as an example of an intermediate transfer body, support rollers 32 to 35 that rotatably support the intermediate transfer belt 31 from the inner peripheral surface, the first-transfer devices 36, a second-transfer device 37, and a belt cleaning device 38. The intermediate transfer unit 30 is disposed at a position located below the image forming units 20 (Y, M. C. K. S) within the internal space of the housing 10.

The intermediate transfer belt 31 is a ring-shaped strip-like belt having a predetermined width and a predetermined length and has an outer peripheral surface that is capable of retaining toner images in accordance with an electrostatic effect.

The support rollers 32 to 35 support the intermediate transfer belt 31 in a substantially inverted-triangular shape and in a rotatable manner in a direction indicated by an arrow.

The support rollers 32 and 33 support the intermediate transfer belt 31 in such a manner as to form a transfer surface extending planarly in the left-right direction via the photoconductor drums 21 of the image forming units 20 (Y, M. C. K. S). The support roller 32 is, for example, a driving roller that applies a driving force for rotating the intermediate transfer belt 31.

The support roller 34 is a second-transfer back roller that supports the inner peripheral surface of the intermediate transfer belt 31 facing the second-transfer device 37. The support roller 35 is, for example, a tension roller that applies a predetermined tension to the intermediate transfer belt 31.

Each first-transfer device 36 is disposed to press the intermediate transfer belt 31 against an area where the photoconductor drum 21 of the corresponding image forming unit 20 (Y, M. C. K. S) performs a first-transfer process.

The second-transfer device 37 transfers the toner images first-transferred on the outer peripheral surface of the intermediate transfer belt 31 onto the recording paper 9. The second-transfer device 37 includes transfer members, such as a transfer roller and a transfer transport belt, which are in contact with the outer peripheral surface of the intermediate transfer belt 31 supported by the support roller 34 and which are supplied with a second-transfer current.

The belt cleaning device 38 cleans the outer peripheral surface of the intermediate transfer belt 31 by removing waste, such as unwanted toner and paper particles, from the outer peripheral surface of the intermediate transfer belt 31.

The medium feeding device 4 accommodates and feeds the recording paper 9 to be fed to a second-transfer position of the intermediate transfer unit 30. For example, the medium feeding device 4 is disposed at a position located below the intermediate transfer unit 30 within the internal space of the housing 10.

The medium feeding device 4 includes containers 41A and 41B that accommodate the recording paper 9 and a delivery device 42 that delivers the recording paper 9 one-by-one from each of the containers 41A and 41B. The recording paper 9 is a medium cut to a predetermined size. The number of containers 41 is not particularly limited.

The fixing device 5 fixes the unfixed toner images second-transferred and retained on the recording paper 9 at the intermediate transfer unit 30 onto the recording paper 9. For example, the fixing device 5 is disposed at a position located diagonally below one side of the intermediate transfer unit 30 within the internal space of the housing 10. The fixing device 5 will be described in detail later.

The transport path 45 includes a path extending from the containers 41A and 41B of the medium feeding device 4 to the fixing device 5 via an area where the intermediate transfer unit 30 performs a second-transfer process, and a path ultimately extending from the fixing device 5 to a medium outlet 10e of the housing 10.

The transport path 45 has disposed thereon, for example, multiple pairs of transport rollers 46a, 46b, 46c, 46d, 46c, and 46f, a suction belt transport device 47, and a transport guide member (not shown). The suction belt transport device 47 is disposed within a path connecting between the area where the intermediate transfer unit 30 performs the second-transfer process and the fixing device 5.

An output section (not shown) that accommodates the recording paper 9 output from the medium outlet 10e is provided outside the housing 10. Examples of the output section include a container tray that accommodates the output recording paper 9 and a post-processing device that performs predetermined processing on the output recording paper 9.

### 1.2. Operation of Image Forming Apparatus

In the image forming apparatus 1, when the controller (not shown) receives an operation command for forming an image from, for example, an external apparatus, the following series of basic image forming operation is performed.

First, in the image forming section 2 of the image forming apparatus 1, any one of the image forming units 20 (Y, M. C. K. S) executes a charging operation, an exposure operation, a developing operation, and a cleaning operation, and the intermediate transfer unit 30 of the image forming section 2 executes a first-transfer operation and a second-transfer operation. On the other hand, in the image forming apparatus 1, a feeding operation of the recording paper 9 is executed at the medium feeding device 4 and the transport path 45.

Accordingly, in the image forming section 2, a toner image is formed on the photoconductor drum 21 of any one of the image forming units 20 (Y. M. C, K, S). Then, the toner image is first-transferred onto the intermediate transfer belt 31 of the intermediate transfer unit 30 and is subsequently second-transferred onto the recording paper 9.

Subsequently, in the image forming apparatus 1, the recording paper 9 having the toner image second-transferred thereon at the intermediate transfer unit 30 of the image forming section 2 is guided and transported to the fixing device 5 in accordance with a transport operation along the transport path 45, and then undergoes a fixing operation at the fixing device 5.

Accordingly, the unfixed toner image is fixed onto the recording paper 9.

The recording paper 9 having undergone the fixing operation is transported in accordance with the transport operation along the transport path 45, and is subsequently output to the output section (not shown) disposed outside the housing 10.

Accordingly, in the image forming apparatus 1, the basic image forming operation involving forming an image formed of toner onto one face of a single sheet of recording paper 9 is completed.

In this case, for example, if the image forming operation is performed at all of the image forming units 20 (Y, M. C. K), a so-called full color image constituted of toner images of four colors (Y, M, C, and K) is formed. Furthermore, in the image forming apparatus 1, a toner image of the special color (S) is formable by performing the image forming operation at the image forming unit 20S, where appropriate.

### 1.3. Configuration of Fixing Device

As shown in FIG. 2, the fixing device 5 has devices, such as a heating rotating body 51 and a pressing rotating body 52, disposed within an internal space of a box-shaped housing 50 provided with an inlet 50a and an outlet 50b for the recording paper 9.

As shown in FIG. 2, the heating rotating body 51 is a belt-pad-type rotating body. The belt-pad-type heating rotating body 51 includes, for example, an endless fixing belt 53, a presser body 54 that supports the fixing belt 53 from the inner peripheral surface thereof and that presses the outer peripheral surface thereof against the pressing rotating body 52, and multiple support rollers 55 and 56 that rotatably support the fixing belt 53 in cooperation with the presser body 54.

The presser body 54 and the support rollers 55 and 56 are heated and maintained at a predetermined temperature, such as a fixation temperature, by heaters 57A, 57B, and 57C, such as electrical heaters, disposed therein. The support roller 55 is a driving roller driven by receiving a rotational driving force from a driving device (not shown), and rotates the fixing belt 53 in a direction indicated by an arrow. Furthermore, the support roller 56 is an adjustment roller that applies a predetermined tension to the fixing belt 53 and that moves to correct meandering of the fixing belt 53.

The presser body 54 and the support rollers 55 and 56 are supported by a support frame (not shown).

The pressing rotating body 52 is, for example, a roller-type pressing roller 58.

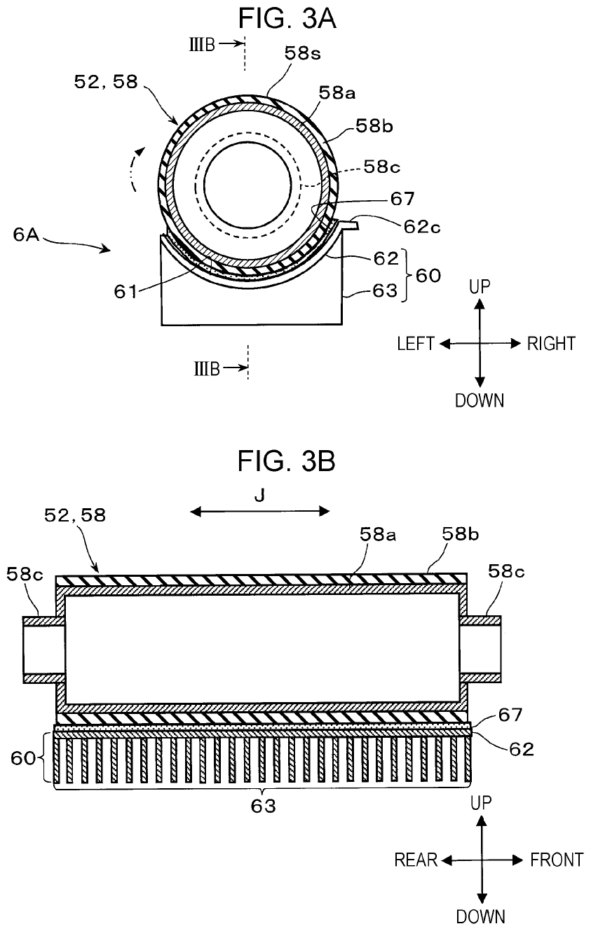

As shown in FIGS. 3A and 3B, the pressing roller 58 includes, for example, a cylindrical roller base 58a composed of metal, and an elastic layer 58b composed of rubber or synthetic resin and formed on the outer peripheral surface of the roller base 58a. The roller base 58a has shafts 58c that protrude from the opposite axial ends thereof and that are rotatably supported by bearings.

The pressing roller 58 is provided in a rotatable manner on the support frame (not shown). The pressing roller 58 is disposed such that the fixing belt 53 of the heating rotating body 51 is pressed against the presser body 54 with a predetermined pressure by a pressing mechanism (not shown).

The pressing roller 58 is supported by the aforementioned support frame in such a manner as to move into and out of contact with a portion of the fixing belt 53 supported by the presser body 54. For example, when the image forming operation is not performed, the pressing roller 58 is set in the non-contact state.

Furthermore, the pressing roller 58 is rotationally driven in a direction indicated by an arrow by receiving a rotational driving force from a driving device (not shown). The surface temperature of the pressing roller 58 is measured by a temperature measuring device 59.

In the fixing device 5, a contact section where the heating rotating body 51 and the pressing rotating body 52 are in contact with each other serves as a fixing section (i.e., a so-called fixation nip) FN where, for example, heating and pressing are performed for fixing the unfixed toner image onto the recording paper 9. The aforementioned contact section is specifically a section where the fixing belt 53 and the pressing roller 58 are in contact with each other.

### 1.4. Operation of Fixing Device

In the image forming apparatus 1, when a timing for performing the above-described image forming operation is reached, the fixing device 5 performs the following fixing operation.

First, in the heating rotating body 51 of the fixing device 5, the support roller 55 serving as a driving roller is driven, so that the fixing belt 53 starts rotating in the direction indicated by the arrow to revolve around the presser body 54 and the support rollers 55 and 56. Furthermore, in the heating rotating body 51, the heaters 57A, 57B, and 57C are actuated, so that the presser body 54 and the support rollers 55 and 56 are heated.

On the other hand, in the fixing device 5, the pressing roller 58 starts rotating in the direction indicated by the arrow to cause the fixing belt 53 to pass the presser body 54 while being in pressure contact therewith.

Accordingly, in the fixing device 5, the fixing belt 53 in a heated and pressed state rotates to pass through the fixing section FN. In this case, the pressing roller 58 rotates while being in contact with the heated fixing belt 53.

Then, in the fixing device 5, the recording paper 9 having the toner image second-transferred thereon at the intermediate transfer unit 30 is guided to and passed through the fixing section FN.

As a result, the toner image and the recording paper 9 are heated and pressed in the process of passing through the fixing section FN, whereby the toner image is ultimately fused and fixed onto the recording paper 9.

Accordingly, the fixing operation for fixing the toner image onto the single sheet of recording paper 9 is completed.

### 1.5. Configuration of Rotating-Body Cooling Structure

As shown in FIG. 2, in the fixing device 5, a rotating-body cooling structure 6A is employed as a structure for cooling the pressing rotating body 52 as an example of a rotating body.

The rotating-body cooling structure 6A includes the pressing roller 58 serving as the pressing rotating body 52, a heat dissipator 60 that is in contact with an outer peripheral surface 58s of the pressing roller 58 with a sliding member 67 interposed therebetween, and an air blower 70 that blows air.

The outer peripheral surface 58s of the pressing roller 58 according to the first exemplary embodiment specifically serves as an outer surface of the elastic layer 58b to be described later.

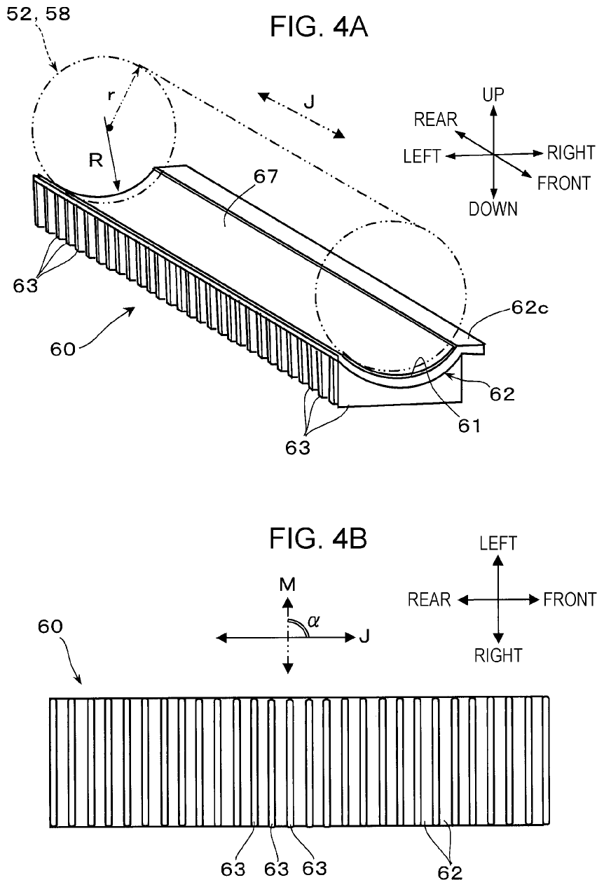

As shown in FIGS. 3A to 4B, the heat dissipator 60 in the cooling structure 6A is a structure having a base 62 and multiple radiator plates 63.

The base 62 is a tabular part extending in an axial direction J of the pressing roller 58.

The base 62 has a curved portion 61 at the face opposite the one face where the radiator plates 63 exist. The curved portion 61 has a curved surface with a circular-arc-shaped curve in cross section.

The curved portion 61 is a part of the heat dissipator 60 having the surface that is in contact with the outer peripheral surface 58s of the pressing roller 58. With regard to the curved portion 61, the curved surface thereof substantially corresponding to a curved surface serving as a circumferential part of the outer peripheral surface 58s of the pressing roller 58 extends in a recessed manner in the axial direction J of the pressing roller 58. For example, the curved portion 61 may be in contact with the outer peripheral surface 58s of the pressing roller 58 in a largest settable range. In other words, if possible, it is effective that the curved portion 61 be in contact with half or more of the outer peripheral surface 58s of the pressing roller 58 in the circumferential direction.

The base 62 according to the first exemplary embodiment is provided with, for example, an attachment portion 62c protruding substantially horizontally (i.e., rightward in FIGS. 3A to 4B) from one end of the pressing roller 58 extending in the axial direction J.

As shown in FIG. 4A, the curved surface of the curved portion 61 has a curvature radius R that is equal to a radius r of the pressing roller 58. Alternatively, the curvature radius R of the curved surface of the curved portion 61 may be slightly larger than the radius r of the pressing roller 58.

The expression “slightly larger” in this case implies that the curvature radius R is longer than the radius r by a factor of 1 and is within a range equal to or less than 1.05 times the radius r.

If the curvature radius R is greater than 1.2 times the radius r, the contact area between the heat dissipator 60 and the outer peripheral surface 58s of the pressing roller 58 tends to decrease, thus making it difficult for the heat dissipator 60 to achieve a favorable heat dissipation effect.

The radiator plates 63 are tabular parts provided for enhancing the heat dissipation effect of the heat dissipator 60. The radiator plates 63 are plates having a predetermined size and a predetermined shape and are also called radiator fins. A predetermined plural number of radiator plates 63 are provided.

The multiple radiator plates 63 are provided at one face of the base 62 so as to be arranged at a predetermined pitch in the axial direction J of the pressing roller 58. The one face of the base 62 is opposite the face where the curved portion 61 exists.

As shown in FIG. 4B, the multiple radiator plates 63 each extend in a direction M intersecting the axial direction J of the pressing roller 58.

In this case, with regard to the intersecting direction M, for example, an intersection angle a with the axial direction J is preferably within the range of ±30°, and the intersection angle a is more preferably within the range of ±5°.

If the intersection angle a exceeds the range of ±30°, heat dissipated from the multiple radiator plates 63 is less likely to be discharged from between the radiator plates 63, thus making it difficult for the radiator plates 63 to achieve a heat dissipation effect. This tendency is more prominent when the air from the air blower 70 is blown onto the radiator plates 63.

The heat dissipator 60 is manufactured by using a metallic material, such as aluminum.

The heat dissipator 60 is disposed in contact with a lower region of the outer peripheral surface 58s of the pressing roller 58. The heat dissipator 60 may be disposed in contact with any partial circumferential region of the outer peripheral surface 58s of the pressing roller 58 so long as the heat dissipator 60 does not impede the fixing operation.

The sliding member 67 reduces frictional resistance in an area where the curved portion 61 of the heat dissipator 60 is in contact with the outer peripheral surface of the rotating fixing belt 53, thereby ensuring sliding performance to allow the fixing belt 53 to rotate with no difficulty.

The sliding member 67 used is, for example, a sheet-like member. The sliding member 67 is attached to cover the curved surface of the curved portion 61 of the heat dissipator 60. The sliding member 67 is secured by, for example, thermal compression bonding or adhesive-based bonding.

The sliding member 67 may have low frictional properties, heat resistance, abrasion resistance, and thermal conductivity. The sliding member 67 used may be, for example, a synthetic resin sheet composed of fluorine-based resin or glass-fiber cloth impregnated with fluorine-based resin. The sliding member 67 may have any thickness, but may preferably have, for example, a thickness smaller than or equal to 1 mm from the standpoint of ensuring favorable thermal conductivity.

As shown in FIG. 2, the air blower 70 in the cooling structure 6A includes a blower body 71 that generates air to be blown, and a blower duct 74 that guides the air released from the blower body 71 and blows the air toward a predetermined target.

The blower body 71 is a part that generates air to be blown.

The blower body 71 according to the first exemplary embodiment is disposed outside the housing 50 of the fixing device 5, and includes a driving unit 72 having rotating fans and a cover member that covers the driving unit 72.

The blower body 71 is disposed at an upstream position, in the transport direction of the recording paper 9, outside the housing 50. In other words, the blower body 71 is disposed at a position located between the second-transfer area of the intermediate transfer unit 30 and the fixing device 5.

For example, the driving unit 72 is disposed such that three rotating fans thereof are arranged in the axial direction J of the pressing roller 58. The cover member (not shown) has an intake port and a discharge port.

The blower duct 74 has one end connected to the discharge port of the blower body 71 and the other end disposed to extend into the housing 50 of the fixing device 5. The tip of the other end is provided with a blower port 74b from which air is blown. The blower port 74b is, for example, a rectangular opening extending in the axial direction J of the pressing roller 58.

The air blower 70 is configured to blow air E (see FIG. 2) generated in the blower body 71 onto at least the heat dissipator 60 via the blower duct 74.

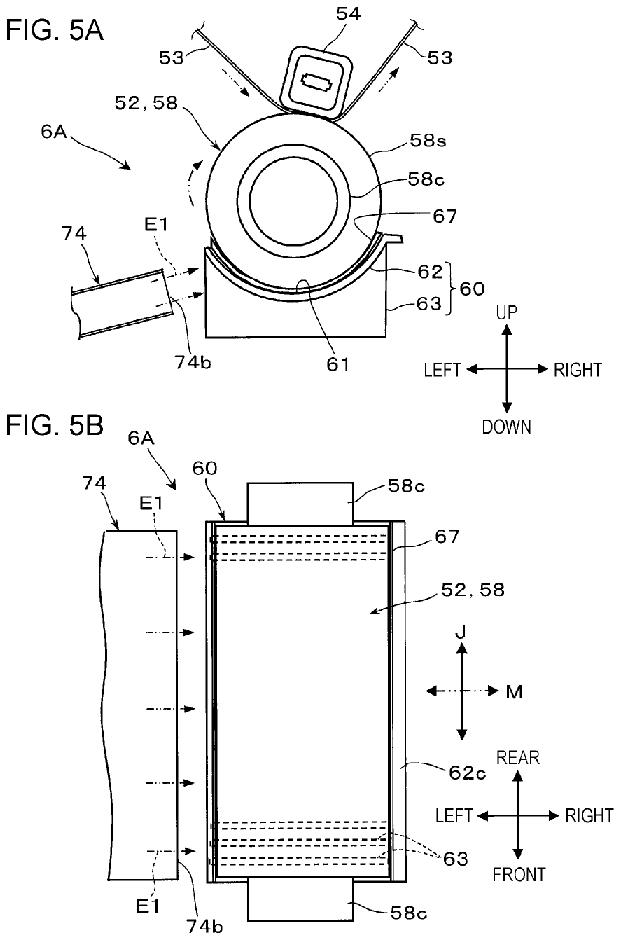

In detail, as shown in FIGS. 5A and 5B, the blower duct 74 is designed to blow air E1 directly onto the radiator plates 63 of the heat dissipator 60 from the blower port 74b.

In FIG. 5B, some of the radiator plates 63 are briefly indicated with dashed lines.

### 1.6. Operation of Rotating-Body Cooling Structure

In the fixing device 5, when a timing for performing the above-described image forming operation is reached, the rotating-body cooling structure 6A performs the following cooling operation.

In the fixing device 5, the pressing roller 58 rotates while being in contact with the heated fixing belt 53 at the timing when the fixing operation is performed, so that the pressing roller 58 receives the heat from the fixing belt 53, whereby the outer peripheral surface 58s of the pressing roller 58 increases in temperature as compared with when the fixing device 5 is stopped (i.e., before the fixing device 5 is actuated).

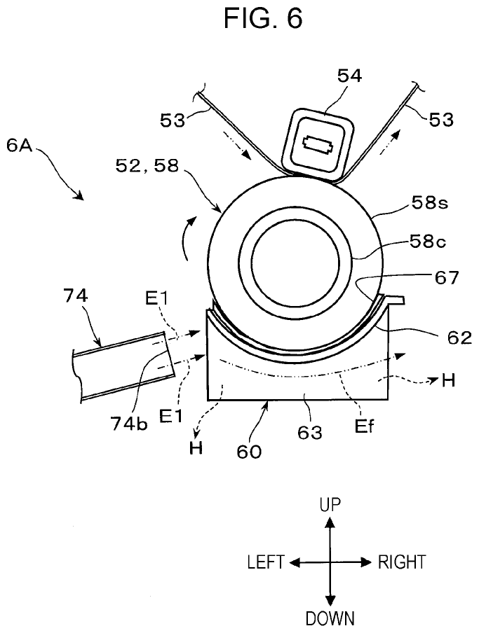

In this case, as shown in FIGS. 5A to 6, the pressing roller 58 rotates while being in contact with the curved portion 61 of the heat dissipator 60 in the cooling structure 6A with the sliding member 67 interposed therebetween. Furthermore, in the cooling structure 6A, the air blower 70 starts operating so as to blow the air E1 toward the heat dissipator 60.

Accordingly, in the heat dissipator 60 in the cooling structure 6A, the heat of the pressing roller 58 increased in temperature is conducted via the sliding member 67, and the heat is substantially released from the multiple radiator plates 63. In FIG. 6, a dashed arrow denoted by reference sign H schematically indicates the heat released from the heat dissipator 60.

As a result, the pressing roller 58 is cooled as a result of the heat thereof being dissipated by the heat dissipator 60 disposed entirely in contact with the partial circumferential region of the outer peripheral surface 58s in the axial direction J. In this case, since the pressing roller 58 is in contact with the heat dissipator 60 with the sliding member 67 interposed therebetween, the pressing roller 58 rotates smoothly with hardly any difficulty in the rotation thereof.

In the cooling structure 6A, the air E1 is blown directly onto the heat dissipator 60 from the air blower 70, so that an air flow Ef flowing through in contact with the heat dissipator 60 is generated, as shown in FIG. 6, whereby the heat is dissipated efficiently in the heat dissipator 60.

As a result, the pressing roller 58 may be cooled as a result of the heat thereof being dissipated efficiently by the heat dissipator 60, as compared with a case where the air blower 70 does not blow the air E1 onto the heat dissipator 60.

Accordingly, in the cooling structure 6A, for example, the speed and the volume of the air E1 blown by the air blower 70 may be reduced in accordance with the heat dissipated by the heat dissipator 60 of the cooling structure 6A, as compared with a cooling structure that cools the outer peripheral surface 58s of the pressing roller 58 by directly blowing air thereto. Consequently, in the cooling structure 6A, the driving speed of the driving unit 72, such as the rotating fans, in the air blower 70 may be reduced, so that operating noise may be suppressed.

Accordingly, in the fixing device 5 equipped with this cooling structure 6A, the pressing roller 58 serving as the pressing rotating body 52 may be cooled efficiently while noise may be suppressed, as compared with a cooling structure not equipped with the heat dissipator 60 that is in contact with the outer peripheral surface 58s of the pressing roller 58 with the sliding member 67 interposed therebetween or a cooling structure in which the air blower 70 does not blow the air E1 onto the heat dissipator 60.

Furthermore, in the cooling structure 6A, the heat dissipator 60 allows the circular-arc-shaped curved portion 61 to be in contact with the outer peripheral surface 58s of the pressing roller 58 (with the sliding member 67 interposed therebetween).

Therefore, in the cooling structure 6A, a large contact area may be readily ensured between the heat dissipator 60 and the outer peripheral surface 58s of the pressing roller 58, so that the pressing roller 58 may be cooled efficiently, as compared with a case where the heat dissipator 60 allows a different-shaped surface (e.g., flat or inverted-curved surface), instead of the circular-arc-shaped curved surface, to be in contact with the outer peripheral surface 58s of the pressing roller 58.

Furthermore, the cooling structure 6A has a relationship (R≥ r) in which the curvature radius R of the curved portion 61 of the heat dissipator 60 is equal to the radius r of the pressing roller 58 or is slightly larger than the radius r.

Therefore, in the cooling structure 6A, a large contact arca may be readily ensured and a stable contact state may be readily obtained between the heat dissipator 60 and the outer peripheral surface 58s of the pressing roller 58, so that the pressing roller 58 may be cooled efficiently, as compared with a case where the curvature radius R of the curved portion 61 of the heat dissipator 60 is smaller than the radius r of the pressing roller 58 (R<r)

Furthermore, in the cooling structure 6A, the multiple radiator plates 63 of the heat dissipator 60 each extend in the direction M intersecting the axial direction J of the pressing roller 58.

Therefore, in the cooling structure 6A, the heat from the multiple radiator plates 63 may be readily dissipated, and the blown air may flow smoothly through between the multiple radiator plates 63, so that the pressing roller 58 may be cooled efficiently, as compared with a case where the multiple radiator plates 63 of the heat dissipator 60 each extend in the axial direction J of the pressing roller 58.

### Second Exemplary Embodiment

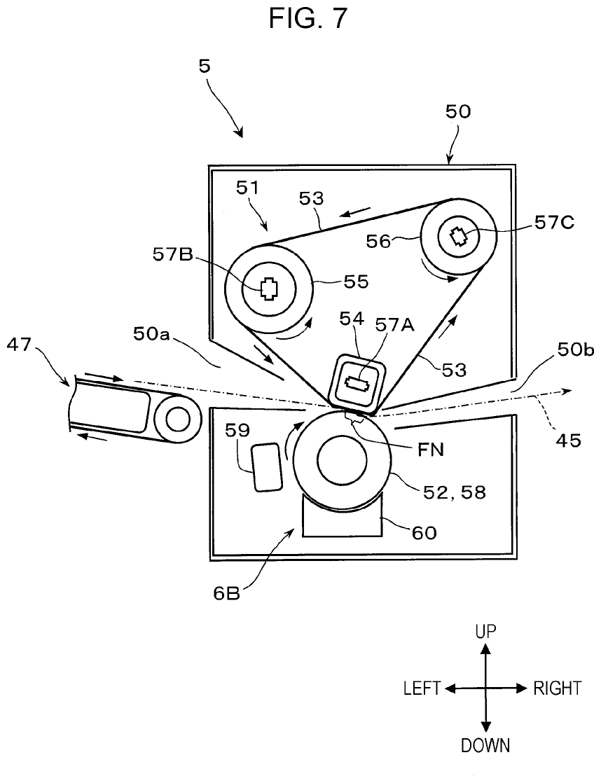

FIG. 7 schematically illustrates a fixing device equipped with a rotating-body cooling structure according to a second exemplary embodiment of the present disclosure.

The fixing device 5 according to the second exemplary embodiment is the same as the fixing device 5 according to the first exemplary embodiment except for an alteration in which a rotating-body cooling structure 6B having a configuration different from that of the rotating-body cooling structure 6A according to the first exemplary embodiment is employed. Furthermore, this fixing device 5 is used as the fixing device in the image forming apparatus 1 according to the first exemplary embodiment.

### 2.1. Configuration of Rotating-Body Cooling Structure

As shown in FIG. 7, the rotating-body cooling structure 6B according to the second exemplary embodiment is not equipped with the air blower 70, and includes the pressing roller 58 and the heat dissipator 60 that is in contact with the outer peripheral surface 58s of the pressing roller 58 with the sliding member 67 interposed therebetween.

The heat dissipator 60 and the sliding member 67 in the cooling structure 6B are the same as the heat dissipator 60 and the sliding member 67 in the rotating-body cooling structure 6A according to the first exemplary embodiment.

### 2.2. Operation of Rotating-Body Cooling Structure

In the fixing device 5 according to the second exemplary embodiment, when a timing for performing the above-described image forming operation is reached, the rotating-body cooling structure 6B performs the following cooling operation.

Specifically, the fixing device 5 is similar to that described in the first exemplary embodiment in that the pressing roller 58 receives heat from the fixing belt 53 at the timing when the fixing operation is performed, whereby the outer peripheral surface 58s of the pressing roller 58 increases in temperature as compared with when the fixing device 5 is stopped.

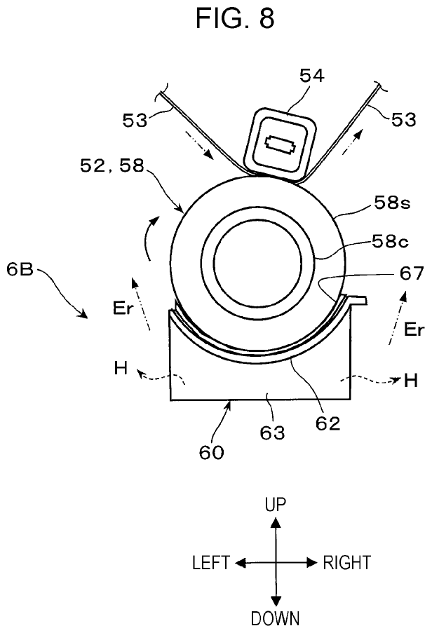

In this case, as shown in FIG. 8, the pressing roller 58 rotates while being in contact with the curved portion 61 of the heat dissipator 60 in the cooling structure 6B with the sliding member 67 interposed therebetween.

Accordingly, in the heat dissipator 60 in the cooling structure 6B, the heat of the pressing roller 58 increased in temperature is conducted to the heat dissipator 60 via the sliding member 67, and the heat is substantially released from the multiple radiator plates 63. In FIG. 8, a dashed arrow denoted by reference sign H schematically indicates the heat released from the heat dissipator 60. Furthermore, the heat (i.e., hot air) released from the heat dissipator 60 is dissipated in accordance with an upward current Er in natural convection occurring within the housing 50 of the fixing device 5.

As a result, the pressing roller 58 is cooled as a result of the heat thereof being dissipated by the heat dissipator 60 disposed entirely in contact with the partial circumferential region of the outer peripheral surface 58s in the axial direction J.

Because the cooling structure 6B is not equipped with the air blower 70 of the cooling structure 6A according to the first exemplary embodiment, operating noise of the air blower 70 does not occur.

Accordingly, in the fixing device 5 equipped with this cooling structure 6B, the pressing roller 58 serving as the pressing rotating body 52 may be cooled efficiently while noise may be suppressed, as compared with a cooling structure not equipped with the heat dissipator 60 that is in contact with the outer peripheral surface 58s of the pressing roller 58 with the sliding member 67 interposed therebetween.

In particular, because this fixing device 5 is not equipped with the air blower 70, operating noise of the air blower 70 does not occur, so that noise may be greatly suppressed accordingly.

In the fixing device 5 equipped with this cooling structure 6B, the heat dissipator 60 is the same as the heat dissipator 60 in the cooling structure 6A according to the first exemplary embodiment, so that the above-described effects of the fixing device 5 according to the first exemplary embodiment may be similarly achieved.

### Third Exemplary Embodiment

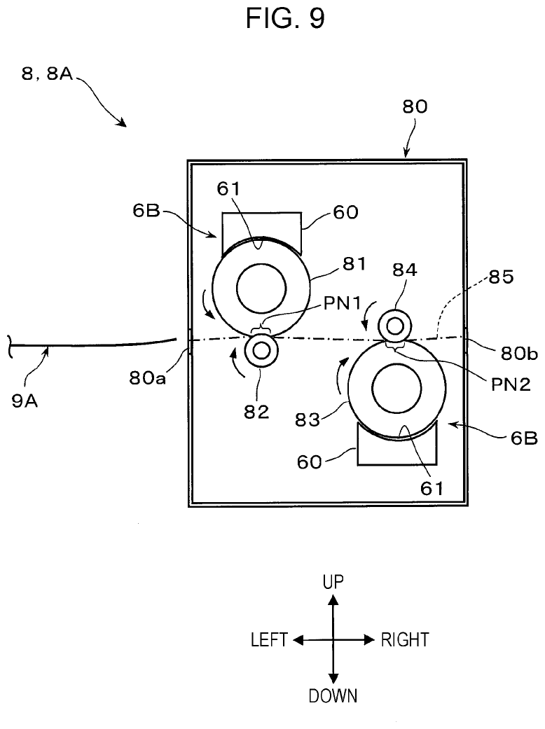

FIG. 9 schematically illustrates an uncurling device 8A as an example of a medium adjustment device 8 equipped with rotating-body cooling structures according to a third exemplary embodiment of the present disclosure.

### 3.1. Configuration of Uncurling Device

The uncurling device 8A causes recording paper 9A as an example of a recording medium that has increased in temperature and is curled as a result of receiving heat from the outside to pass through rotating bodies while being in contact therewith so as to substantially uncurl the recording paper 9A.

The uncurling device 8A according to the third exemplary embodiment includes a first pressing nip PN1, a second pressing nip PN2, and a transport path 85 for the recording paper 9A that are provided inside a housing 80.

The housing 80 is a box-shaped structure provided with an inlet 80a and an outlet 80b for the recording paper 9A.

The first pressing nip PN1 presses against the recording paper 9A and allows the recording paper 9A to pass therethrough in a state where the recording paper 9A is curved upward.

The first pressing nip PN1 is where a first rotation roller 81 and a first pressing roller 82 are in contact with each other. The first rotation roller 81 rotates in a direction indicated by an arrow. The first pressing roller 82 rotates in a direction indicated by an arrow by being in pressure contact with a substantially lowermost outer peripheral surface of the first rotation roller 81.

The first rotation roller 81 has an elastic surface layer (not shown) and rotates in the direction indicated by the arrow by receiving a rotational driving force from a driving device (not shown). The first pressing roller 82 is a rigid roller having higher rigidity than the elastic surface layer of the first rotation roller 81 and rotates in the direction indicated by the arrow by being driven by the rotation of the first rotation roller 81.

The second pressing nip PN2 presses against the recording paper 9A that has passed through the first pressing nip PN1 and allows the recording paper 9A to pass therethrough in a state where the recording paper 9A is curved downward.

The second pressing nip PN2 is where a second rotation roller 83 and a second pressing roller 84 are in contact with each other. The second rotation roller 83 rotates in a direction indicated by an arrow. The second pressing roller 84 rotates in a direction indicated by an arrow by being in pressure contact with a substantially uppermost outer peripheral surface of the second rotation roller 83.

The second rotation roller 83 has an elastic surface layer (not shown) and rotates in the direction indicated by the arrow by receiving a rotational driving force from a driving device (not shown). The second pressing roller 84 is a rigid roller having higher rigidity than the elastic surface layer of the second rotation roller 83 and rotates in the direction indicated by the arrow by being driven by the rotation of the second rotation roller 83.

The transport path 85 allows the recording paper 9A introduced through the inlet 80a of the housing 80 to pass through the first pressing nip PN1 and the second pressing nip PN2 in this order, and subsequently allows the recording paper 9A to be output from the outlet 80b of the housing 80.

The transport path 85 is constituted of, for example, a transport guide member (not shown) that guides the recording paper 9A in the transport direction thereof.

### 3.2. Operation of Uncurling Device

When the uncurling device 8A is actuated, the first rotation roller 81 and the second rotation roller 83 start to rotate in the respective directions indicated by the arrows. Moreover, in the uncurling device 8A, the first pressing roller 82 and the second pressing roller 84 are rotationally driven by being in contact in an engaged fashion to predetermined depths with the elastic surface layer of the first rotation roller 81 and the elastic surface layer of the second rotation roller 83, respectively.

Then, in the uncurling device 8A, the recording paper 9A is introduced into the housing 80 and is transported along the transport path 85 to pass through the first pressing nip PN1 and the second pressing nip PN2 in this order.

In this case, the recording paper 9A is pressed onto the first rotation roller 81 from below by the first pressing roller 82 at the first pressing nip PN1, so as to pass therethrough in a state where the recording paper 9A is temporarily curved upward. With regard to the recording paper 9A, for example, a curled part thereof curved downward is corrected.

The recording paper 9A that has passed through the first pressing nip PN1 is pressed onto the second rotation roller 83 from below by the second pressing roller 84 at the second pressing nip PN2, so as to pass therethrough in a state where the recording paper 9A is temporarily curved downward. With regard to the recording paper 9A, for example, a curled part thereof curved upward is corrected.

Accordingly, the curled recording paper 9A prior to being introduced to the uncurling device 8A is substantially uncurled as a result of the recording paper 9A passing through the first pressing nip PN1 and the second pressing nip PN2 of the uncurling device 8A.

For example, in order to eliminate curl existing in recording paper 9 to be output from a fixing device in an image forming apparatus, the uncurling device 8A is disposed within a sheet transport path located downstream in the transport direction of the recording paper 9 in the fixing device. The recording paper 9 introduced to the uncurling device 8A in this usage example has an image fixed thereon at the fixing device.

If the recording paper 9A that has increased in temperature and is curled as a result of receiving heat from the outside exists independently, the uncurling device 8A may be used as an independent device.

### 3.3. Configuration of Rotating-Body Cooling Structures

As shown in FIG. 9, the uncurling device 8A is equipped with two rotating-body cooling structures 6B as structures for cooling the first rotation roller 81 and the second rotation roller 83, respectively.

The rotating-body cooling structures 6B according to the third exemplary embodiment are substantially similar to the rotating-body cooling structure 6B according to the second exemplary embodiment (see FIG. 8) in being equipped with heat dissipators 60 that are in contact with the outer peripheral surfaces of the first rotation roller 81 and the second rotation roller 83 with the sliding members 67 interposed therebetween.

The outer peripheral surfaces of the first rotation roller 81 and the second rotation roller 83 specifically serve as the outer surfaces of the aforementioned elastic surface layers.

The heat dissipator 60 and the sliding member 67 in each cooling structure 6B according to the third exemplary embodiment are substantially the same as the heat dissipator 60 and the sliding member 67 in the rotating-body cooling structure 6A according to the first exemplary embodiment.

### 3.4. Operation of Rotating-Body Cooling Structures

When the uncurling device 8A is actuated, the rotating-body cooling structures 6B perform the following cooling operation.

First, in the uncurling device 8A, the recording paper 9A that has increased in temperature and is curled as a result of receiving heat from the outside passes through the first pressing nip PN1 and the second pressing nip PN2.

Therefore, the first rotation roller 81 at the first pressing nip PN1 and the second rotation roller 83 at the second pressing nip PN2 through which the recording paper 9A passes while being in contact therewith receive heat from the recording paper 9A, so that the temperature of the outer peripheral surface of each roller is higher than the temperature when the uncurling device 8A is stopped.

Moreover, as shown in FIG. 9, each of the first rotation roller 81 and the second rotation roller 83 rotates while being in contact with the curved portion 61 of the heat dissipator 60 in the corresponding cooling structure 6B with the sliding member 67 (see FIG. 8) interposed therebetween.

Accordingly, in the cooling structures 6B, the heat of the first rotation roller 81 and second rotation roller 83 increased in temperature is conducted to the heat dissipators 60 via the sliding members 67 (see FIG. 8), and the heat is substantially released from the multiple radiator plates 63 (see FIG. 8). Furthermore, the heat (i.e., hot air) released from each heat dissipator 60 is dissipated in accordance with an upward current in natural convection occurring within the housing 80 of the uncurling device 8A (see FIG. 8).

As a result, each of the first rotation roller 81 and the second rotation roller 83 is cooled as a result of the heat thereof being dissipated by the corresponding heat dissipator 60 disposed entirely in contact with the partial circumferential region of the outer peripheral surface in the axial direction.

Accordingly, in the uncurling device 8A equipped with the cooling structures 6B, the first rotation roller 81 and the second rotation roller 83 may be cooled efficiently while noise may be suppressed, as compared with cooling structures not equipped with the heat dissipators 60 that are in contact with the first rotation roller 81 and the second rotation roller 83 with the sliding members 67 interposed therebetween.

In particular, because the cooling structures 6B are not equipped with the air blower 70 (see FIG. 2) in this uncurling device 8A, operating noise of the air blower 70 does not occur, so that noise may be greatly suppressed accordingly.

In the uncurling device 8A, the cooling structures 6B cool the first rotation roller 81 and the second rotation roller 83 to avoid a state where the temperature increases more than necessary, so that the uncurling effect may be readily achieved.

### Fourth Exemplary Embodiment

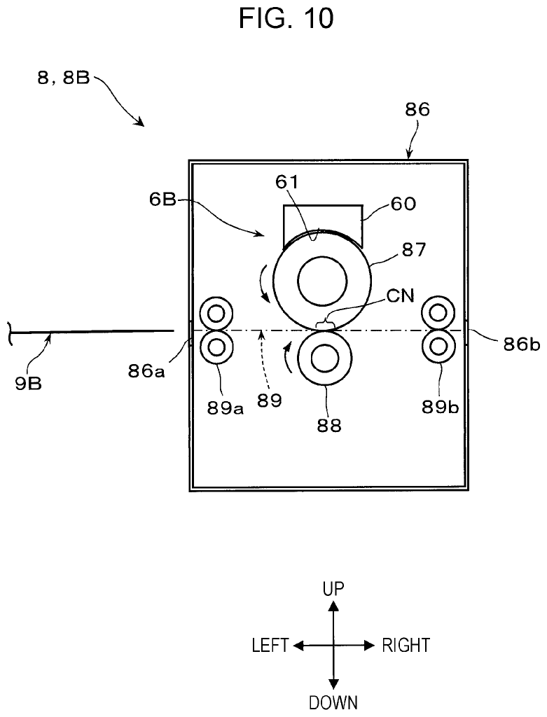

FIG. 10 schematically illustrates a medium cooling device 8B as another example of a medium adjustment device 8 equipped with a rotating-body cooling structure according to a fourth exemplary embodiment of the present disclosure.

### 4.1. Configuration of Medium Cooling Device

The medium cooling device 8B causes recording paper 9B as an example of a recording medium that has increased in temperature as a result of receiving heat from the outside to pass through a rotating body while being in contact therewith, so as to cool the recording paper 9B to a temperature lower than the increased temperature.

The medium cooling device 8B according to the fourth exemplary embodiment includes a cooling section CN and a transport path 89 for the recording paper 9B that are provided inside a housing 86.

The housing 86 is a box-shaped structure provided with an inlet 86a and an outlet 86b for the recording paper 9B.

The cooling section CN transports the recording paper 9B in a nipped state and cools the recording paper 9B.

The cooling section CN is where a cooling rotation roller 87 and a transport rotation roller 88 are in contact with each other. The cooling rotation roller 87 rotates in a direction indicated by an arrow. The transport rotation roller 88 rotates in a direction indicated by an arrow by being in contact with the outer peripheral surface of the cooling rotation roller 87.

The cooling rotation roller 87 is composed of a material with high thermal conductivity, such as metal, and rotates in the direction indicated by the arrow by receiving a rotational driving force from a driving device (not shown). The transport rotation roller 88 has an elastic surface layer (not shown) and rotates in the direction indicated by the arrow by being driven by the rotation of the cooling rotation roller 87.

The transport path 89 allows the recording paper 9B introduced through the inlet 86a of the housing 86 to pass through the cooling section CN, and subsequently allows the recording paper 9B to be output from the outlet 86b of the housing 86.

The transport path 89 is constituted of, for example, a pair of transport rollers 89a and 89b that nip and transport the recording paper 9B and a transport guide member (not shown) that guides the recording paper 9B in the transport direction thereof.

### 4.2. Operation of Medium Cooling Device

When the medium cooling device 8B is actuated, the cooling rotation roller 87 and the pair of transport rollers 89a and 89b start to rotate in predetermined directions. Moreover, in the medium cooling device 8B, the transport rotation roller 88 starts to rotate by being driven by being in contact with the cooling rotation roller 87.

Then, in the medium cooling device 8B, the recording paper 9B is introduced into the housing 86 and is transported along the transport path 89 to pass through the cooling section CN.

In this case, the recording paper 9B is transported by being nipped between the cooling rotation roller 87 and the transport rotation roller 88 at the cooling section CN.

Accordingly, the recording paper 9B passes the cooling rotation roller 87 while being in contact therewith, so that the heat of the recording paper 9B is conducted to the cooling rotation roller 87, whereby the recording paper 9B is cooled.

For example, the medium cooling device 8B is used by being disposed within a transport path for a recording medium in an image forming apparatus. The recording paper 9B is not limited to recording paper having an image formed thereon, and may alternatively be recording paper prior to having an image formed thereon. Moreover, the recording paper 9B may be long strip-like recording paper (such as rolled paper).

If the recording paper 9B that has increased in temperature as a result of receiving heat from the outside exists independently, the medium cooling device 8B may be used as an independent device.

### 4.3. Configuration of Rotating-Body Cooling Structure

As shown in FIG. 10, in the medium cooling device 8B, the rotating-body cooling structure 6B is employed as a structure for cooling the cooling rotation roller 87.

The rotating-body cooling structure 6B according to the fourth exemplary embodiment is substantially similar to the cooling structure 6B according to the second exemplary embodiment (see FIG. 8) in being equipped with the heat dissipator 60 that is in contact with the outer peripheral surface of the cooling rotation roller 87 with the sliding member 67 interposed therebetween.

The heat dissipator 60 and the sliding member 67 in the cooling structure 6B according to the fourth exemplary embodiment are substantially the same as the heat dissipator 60 and the sliding member 67 in the rotating-body cooling structure 6A according to the first exemplary embodiment.

### 4.4. Operation of Rotating-Body Cooling Structure

When the medium cooling device 8B is actuated, the rotating-body cooling structure 6B performs the following cooling operation.

First, in the medium cooling device 8B, the recording paper 9B that has increased in temperature as a result of receiving heat from the outside passes through the cooling section CN.

Therefore, the cooling rotation roller 87 at the cooling section CN through which the recording paper 9B passes while being in contact therewith receives heat from the recording paper 9B, so that the temperature of the outer peripheral surface of the cooling rotation roller 87 is higher than the temperature when the medium cooling device 8B is stopped.

Moreover, as shown in FIG. 10, the cooling rotation roller 87 rotates while being in contact with the curved portion 61 of the heat dissipator 60 in the cooling structure 6B with the sliding member 67 (see FIG. 8) interposed therebetween.

Accordingly, in the cooling structure 6B, the heat of the cooling rotation roller 87 increased in temperature is conducted to the heat dissipator 60 via the sliding member 67 (see FIG. 8), and the heat is substantially released from the multiple radiator plates 63 (see FIG. 8). Furthermore, the heat (i.e., hot air) released from the heat dissipator 60 is dissipated in accordance with an upward current in natural convection occurring within the housing 86 of the medium cooling device 8B (see FIG. 8).

As a result, the cooling rotation roller 87 is cooled as a result of the heat thereof being dissipated by the heat dissipator 60 disposed entirely in contact with the partial circumferential region of the outer peripheral surface in the axial direction.

Accordingly, in the medium cooling device 8B equipped with the cooling structure 6B, the cooling rotation roller 87 may be cooled efficiently while noise may be suppressed, as compared with a cooling structure not equipped with the heat dissipator 60 that is in contact with the cooling rotation roller 87 with the sliding member 67 interposed therebetween.

In particular, because the cooling structure 6B is not equipped with the air blower 70 (see FIG. 2) in this medium cooling device 8B, operating noise of the air blower 70 does not occur, so that noise may be greatly suppressed accordingly.

In the medium cooling device 8B, the cooling structure 6B cools the cooling rotation roller 87 so as to cool the recording paper 9B.

### Modifications

The exemplary embodiments of the present disclosure are not limited to the first to fourth exemplary embodiments described above, and various modifications and alterations are permissible so long as they do not alter the gist defined in the claims. Therefore, for example, the exemplary embodiments of the present disclosure encompass the following modifications.

In the first exemplary embodiment, the air blower 70 in the rotating-body cooling structure 6A is configured to blow the air E1 directly onto the heat dissipator 60 via the blower duct 74.

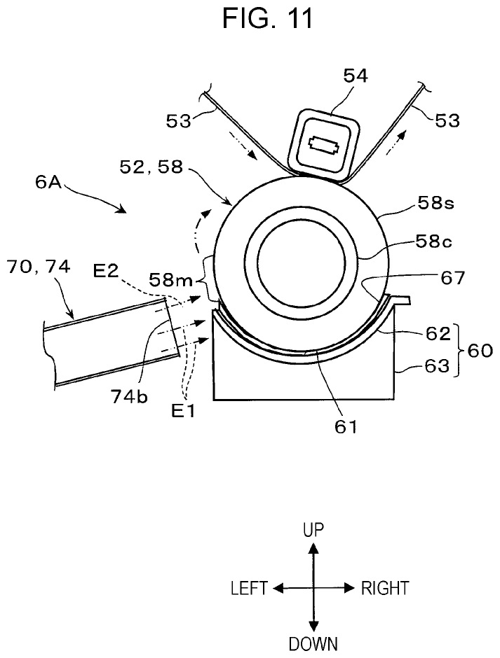

As shown in FIG. 11, in addition to blowing the air E1 directly onto the heat dissipator 60, the air blower 70 in the cooling structure 6A may be configured to blow air E2 onto an area 58m, which is adjacent to the heat dissipator 60, on the outer peripheral surface 58s of the pressing roller 58 serving as the pressing rotating body 52 as an example of a rotating body. This configuration may be achieved by, for example, adjusting the configuration of the blower duct 74 or adjusting how the blower duct 74 is set.

In the case of such a configuration, the pressing roller 58 is cooled (i.e., air-cooled) also by the directly-blown air E2, so that the pressing roller 58 may be cooled efficiently, as compared with a case where the air blower 70 does not blow the air E2 onto the area 58m, which is adjacent to the heat dissipator 60, on the outer peripheral surface 58s of the pressing roller 58 serving as the pressing rotating body 52.

Each of the rotating-body cooling structure 6A described in the first exemplary embodiment and the rotating-body cooling structures 6B described in the second to fourth exemplary embodiments is not limited to a type in which the heat dissipator 60 is constantly in contact with the outer peripheral surface of a rotating body, such as the pressing roller 58, with a sliding member interposed therebetween.

For example, each of the cooling structures 6A and 6B may be of a type in which the heat dissipator 60 is moved into contact with the rotating body when the rotating body rotates and is to be cooled. If the rotating body is shiftable, each of the cooling structures 6A and 6B may be of a type in which the heat dissipator 60 is brought into contact with the rotating body when the rotating body is shifted to a specific position among multiple shift positions.

The heat dissipator 60 used in each of the cooling structures 6A and 6B may be a heat dissipator having multiple radiator protrusions that have a columnar-like or protrusion-like shape and that are arranged in an orderly fashion at a predetermined pitch, in place of the multiple radiator plates 63.

In the fixing device 5 according to each of the first and second exemplary embodiments, the pressing rotating body 52 is not limited to the pressing roller 58 of a roller type, and may be of a belt-pad type.

The pressing rotating body 52 of a belt-pad type includes, for example, an endless pressing belt, a presser body that presses the pressing belt against the heating rotating body 51, and a support roller that rotatably supports the pressing belt in cooperation with the presser body.

If the pressing rotating body 52 of this belt-pad type is used, the heat dissipator 60 in each of the rotating-body cooling structures 6A and 6B may be in contact with the outer peripheral surface of an area of the rotating pressing belt that is supported by the presser body serving as a pad.

Furthermore, in the fixing device 5 according to each of the first and second exemplary embodiments, the heating rotating body 51 used may be of a roller type (i.e., a heating roller).

In the uncurling device 8A according to the third exemplary embodiment, the rotating-body cooling structure 6A equipped with the air blower 70, as in the first exemplary embodiment, may be employed in place of each rotating-body cooling structure 6B.

Furthermore, the uncurling device 8A may employ the rotating-body cooling structure 6B (or cooling structure 6A) in only one of the first pressing nip PN1 and the second pressing nip PN2.

Moreover, the uncurling device 8A may have the first pressing nip PN1 and the second pressing nip PN2 arranged in the reversed order in the transport direction of the recording paper 9A. The uncurling device 8A may include only one of the first pressing nip PN1 and the second pressing nip PN2.

The medium cooling device 8B according to the fourth exemplary embodiment may employ the rotating-body cooling structure 6A equipped with the air blower 70, as in the first exemplary embodiment, in place of the rotating-body cooling structure 6B.

Furthermore, the medium cooling device 8B may use a cooling section provided with a transport cooling roller in place of the transport rotation roller 88 as the cooling section CN. In the case of this cooling section provided with the transport cooling roller, the rotating-body cooling structure 6B (or cooling structure 6A) may be employed as a structure for cooling the transport cooling roller.

Moreover, the cooling section CN disposed in the medium cooling device 8B may include multiple cooling sections CN. Furthermore, the cooling section CN in the medium cooling device 8B may have a positional relationship in which the cooling rotation roller 87 and the transport rotation roller 88 are positionally inverted in the vertical direction.

An image forming apparatus equipped with the fixing device 5 may be an image forming apparatus equipped with the image forming section 2 that employs a direct transfer technique involving directly transferring an unfixed image onto the recording paper 9, instead of the image forming section 2 using the intermediate transfer unit 30, that is, an intermediate transfer technique.

An image forming apparatus equipped with the medium adjustment device 8, as represented by the uncurling device 8A or the medium cooling device 8B, may be an image forming apparatus that employs an image forming technique other than the technique involving forming an unfixed image formed of a developer. An image forming technique other than the technique involving forming an unfixed image formed of a developer is, for example, an inkjet-based image forming technique.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1))) A rotating-body cooling structure comprising:
a rotating body that increases in temperature as a result of receiving heat from an outside; and
a heat dissipator that is in contact with an outer peripheral surface of the rotating body with a sliding member interposed therebetween.

(((2))) The rotating-body cooling structure according to (((1))),
wherein the heat dissipator has a circular-arc-shaped curved portion and allows the curved portion to be in contact with the outer peripheral surface of the rotating body.

(((3))) The rotating-body cooling structure according to (((2))),
wherein the curved portion has a curvature radius that is equal to a radius of the rotating body or that is slightly larger than the radius.

(((4))) The rotating-body cooling structure according to any one of (((1))) to (((3))),
wherein the heat dissipator has a tabular base and a plurality of radiator plates arranged at one face of the base, and
wherein the plurality of radiator plates are each provided to extend in a direction intersecting an axial direction of the rotating body.

(((5))) The rotating-body cooling structure according to any one of (((1))) to (((4))), further comprising:
an air blower that blows air,
wherein the air blower blows the air onto the heat dissipator.

(((6))) The rotating-body cooling structure according to (((5))),
wherein the heat dissipator has a tabular base and a plurality of radiator plates arranged at one face of the base, and
wherein the plurality of radiator plates are each provided to extend in a direction intersecting an axial direction of the rotating body.

(((7))) The rotating-body cooling structure according to (((5))) or (((6))),
wherein the air blower blows the air onto an area of the outer peripheral surface of the rotating body, the area being adjacent to the heat dissipator.

(((8))) A fixing device comprising:
a heating rotating body that has a heater; and
a pressing rotating body that is in contact with the heating rotating body while applying pressure thereto and that forms a fixing section through which a recording medium retaining an unfixed image passes,
wherein a structure that cools the pressing rotating body includes the rotating-body cooling structure according to any one of (((1))) to (((7))).

(((9))) A medium adjustment device comprising:
a rotating body that allows a recording medium increased in temperature to pass while being in contact therewith so as to adjust the recording medium,
wherein a structure that cools the rotating body includes the rotating-body cooling structure according to any one of (((1))) to (((7))).

(((10))) An image forming apparatus comprising:
an image forming section that forms an unfixed image and transfers the unfixed image onto a recording medium; and
a fixing device that fixes the unfixed image transferred at the image forming section onto the recording medium,
wherein the fixing device includes the fixing device according to (((8))).

(((11))) An image forming apparatus comprising:
a medium adjustment device that allows a recording medium increased in temperature to pass through a rotating body while being in contact therewith so as to adjust the recording medium,
wherein the medium adjustment device includes the medium adjustment device according to (((9))).

What is claimed is:

1. A rotating-body cooling structure comprising:
a rotating body that increases in temperature as a result of receiving heat from an outside; and
a heat dissipator that is in contact with an outer peripheral surface of the rotating body with a sliding member interposed therebetween.

2. The rotating-body cooling structure according to claim 1,
wherein the heat dissipator has a circular-arc-shaped curved portion and allows the curved portion to be in contact with the outer peripheral surface of the rotating body.

3. The rotating-body cooling structure according to claim 2,
wherein the curved portion has a curvature radius that is equal to a radius of the rotating body or that is slightly larger than the radius.

4. The rotating-body cooling structure according to claim 1,
wherein the heat dissipator has a tabular base and a plurality of radiator plates arranged at one face of the base, and
wherein the plurality of radiator plates are each provided to extend in a direction intersecting an axial direction of the rotating body.

5. The rotating-body cooling structure according to claim 1, further comprising:
an air blower that blows air,
wherein the air blower blows the air onto the heat dissipator.

6. The rotating-body cooling structure according to claim 5,
wherein the heat dissipator has a tabular base and a plurality of radiator plates arranged at one face of the base, and
wherein the plurality of radiator plates are each provided to extend in a direction intersecting an axial direction of the rotating body.

7. The rotating-body cooling structure according to claim 5,
wherein the air blower blows the air onto an area of the outer peripheral surface of the rotating body, the area being adjacent to the heat dissipator.

8. A fixing device comprising:
a heating rotating body that has a heater; and
a pressing rotating body that is in contact with the heating rotating body while applying pressure thereto and that forms a fixing section through which a recording medium retaining an unfixed image passes,
wherein a structure that cools the pressing rotating body includes the rotating-body cooling structure according to claim 1.

9. A fixing device comprising:
a heating rotating body that has a heater; and
a pressing rotating body that is in contact with the heating rotating body while applying pressure thereto and that forms a fixing section through which a recording medium retaining an unfixed image passes,
wherein a structure that cools the pressing rotating body includes the rotating-body cooling structure according to claim 2.

10. A fixing device comprising:
a heating rotating body that has a heater; and
a pressing rotating body that is in contact with the heating rotating body while applying pressure thereto and that forms a fixing section through which a recording medium retaining an unfixed image passes,
wherein a structure that cools the pressing rotating body includes the rotating-body cooling structure according to claim 3.

11. A fixing device comprising:
a heating rotating body that has a heater; and
a pressing rotating body that is in contact with the heating rotating body while applying pressure thereto and that forms a fixing section through which a recording medium retaining an unfixed image passes,
wherein a structure that cools the pressing rotating body includes the rotating-body cooling structure according to claim 4.

12. A fixing device comprising:
a heating rotating body that has a heater; and
a pressing rotating body that is in contact with the heating rotating body while applying pressure thereto and that forms a fixing section through which a recording medium retaining an unfixed image passes,
wherein a structure that cools the pressing rotating body includes the rotating-body cooling structure according to claim 5.

13. A fixing device comprising:
a heating rotating body that has a heater; and
a pressing rotating body that is in contact with the heating rotating body while applying pressure thereto and that forms a fixing section through which a recording medium retaining an unfixed image passes,
wherein a structure that cools the pressing rotating body includes the rotating-body cooling structure according to claim 6.

14. A fixing device comprising:
a heating rotating body that has a heater; and
a pressing rotating body that is in contact with the heating rotating body while applying pressure thereto and that forms a fixing section through which a recording medium retaining an unfixed image passes,
wherein a structure that cools the pressing rotating body includes the rotating-body cooling structure according to claim 7.

15. A medium adjustment device comprising:
a rotating body that allows a recording medium increased in temperature to pass while being in contact therewith so as to adjust the recording medium,
wherein a structure that cools the rotating body includes the rotating-body cooling structure according to claim 1.

16. A medium adjustment device comprising:
a rotating body that allows a recording medium increased in temperature to pass while being in contact therewith so as to adjust the recording medium,
wherein a structure that cools the rotating body includes the rotating-body cooling structure according to claim 2.

17. A medium adjustment device comprising:
a rotating body that allows a recording medium increased in temperature to pass while being in contact therewith so as to adjust the recording medium,
wherein a structure that cools the rotating body includes the rotating-body cooling structure according to claim 3.

18. A medium adjustment device comprising:
a rotating body that allows a recording medium increased in temperature to pass while being in contact therewith so as to adjust the recording medium,
wherein a structure that cools the rotating body includes the rotating-body cooling structure according to claim 4.

19. An image forming apparatus comprising:
an image forming section that forms an unfixed image and transfers the unfixed image onto a recording medium; and
a fixing device that fixes the unfixed image transferred at the image forming section onto the recording medium,
wherein the fixing device includes the fixing device according to claim 8.

20. An image forming apparatus comprising:
a medium adjustment device that allows a recording medium increased in temperature to pass through a rotating body while being in contact therewith so as to adjust the recording medium,
wherein the medium adjustment device includes the medium adjustment device according to claim 15.
